(19) United States
(12) Patent Application Publication
(10) Pub. No.: US 2010/0143625 A1
(43) Pub. Date: Jun. 10, 2010

(54) Preform for blow molding a bottle from bioresin

(75) Inventors: Scott W. Steele, Perrysburg, OH (US); Lana Grinberg, Sylvania, OH (US); David Ryan, Toledo, OH (US); Lorinda Yoder, Monclova, OH (US)

Correspondence Address: Michael A. Tobin;K&L Gates, L.L.P., Hearst Tower, 47th Floor, 214 N. Tryon St., Charlotte, NC, 28202, US

(73) Assignee: Primo To Go, LLC, Winston-Salem, NC (US)

(21) Appl. No.: 12/315,648

(22) Filed: Dec. 5, 2008

(51) Int. Cl. B32B 1/00; B29C 45/00

(52) U.S. Cl. 428/35.7; 264/328.1

(57) ABSTRACT

A method of making a bottle whereby a polylactic acid preform is stretch blow molded into a biodegradable bioresin bottle. An injection molded polylactic acid or polylactide preform having a finish, a transition portion, a body portion, and a closed end cap portion for making a blow molded biodegradable bioresin bottle having a substantially circular cross-section and a substantially elliptical cross-section. A biodegradable bioresin bottle having both substantially circular and substantially elliptical cross-sectional shapes. Hoop stiffness and bottle geometry are utilized to control the bottle shape resulting from deformation caused by vacuum creation as water vapor permeates outwardly through the bottle walls.

### FIELD OF THE INVENTION

The present invention relates to a bottle made from a biodegradable bioresin and in particular to a renewable biodegradable bioresin bottle made from plants, not crude oil, comprising polylactic acid or polylactide.

### BACKGROUND OF THE INVENTION

Virtually all “single-serve” or “convenience-size” beverage bottles sold in the United States are made from polyethylene terephthalate (“PET”). PET has become the material of choice for bottled beverages because, among other reasons, of its lightweight and shatter resistance and because PET bottle manufacturing techniques are widely known. A 2007 study by the Container Recycling Institute (“CRI”) estimates that 37 billion of the 58 billion non-carbonated, non-alcoholic beverages purchased in the United States in 2005 were packaged in PET bottles, of which over 27 billion were plastic water bottles having a size of 1 liter or less. CRI also estimates that 96% of bottled water sold in the U.S. in 2005 was sold in PET bottles.

Notwithstanding the wide-spread use and popularity of PET beverage bottles, there are at least four significant disadvantages associated with using PET for making beverage bottles. First, PET is a petroleum-based product. CRI estimates that approximately 18 billion barrels of crude oil equivalent were consumed in 2005 to replace the 2 million tons of PET bottles that were wasted and not recycled. Second, single-serve PET beverage bottles are prone to being littered and have a lower recycle rate than any of the most common beverage packaging materials. CRI estimates that only about 23% of PET beverage bottles sold in the U.S. in 2005 were recycled and that 52 billion plastic bottles and jugs were wasted—i.e., not recycled—in that year. This is problematic because PET is not readily biodegradable and thus littered PET bottles or PET bottles ending up in landfills remain in bottle form indefinitely. Third, production of PET creates a significant amount of green house gases. According to one study, 4 tons of greenhouse gases as CO₂ equivalents are generated for every ton of virgin (i.e., non-recycled) PET produced. Fourth, even when PET is recycled, the chemical properties of PET degrade each time that PET is recycled and thus it is not possible to make an acceptable PET beverage bottle using 100% recycled PET. Rather, recycled PET must be mixed with virgin PET to make acceptable PET beverage bottles. Even if every PET beverage bottle was recycled, there would still be a need for production of virgin PET, with the associated petroleum dependence and green house gas production.

In light of the significant disadvantages associated with PET beverage containers, attention has been given in recent years to the possibility of creating acceptable beverage containers from resins made from renewable, plant-based materials, with the additional benefit of being biodegradable. One such biodegradable bioresin is polylactic acid or polylactide (“PLA”). PLA is a biodegradable, thermoplastic, aliphatic polyester that is derived from renewable resources, such as corn starch or sugarcanes, and thus is not a petroleum-based product. PLA provides several different landfill waste diversion options as compared to PET because PLA can be physically recycled, industrially composted, incinerated or chemically converted back to lactic acid through hydrolysis. In addition, unlike PET, PLA is 100% recyclable and can be recycled into virgin PLA and then used to make PLA bottles without the need to add additional non-recycled PLA.

Unfortunately, the advantages of using PLA instead of PET in the manufacture of beverage bottles have not yet been fully realized because the chemical properties of PLA differ from those of PET in several significant ways and these differences present challenges to the successful manufacture and use of PLA for single serve beverage bottles. With respect to the manufacture of PLA beverage bottles, factors such as the lower density of PLA as compared to PET, the greater risk of inadvertent occurrence of thermal crystallization in PLA as compared to PET, the lower mechanical strength of PLA as compared to PET, and lower melt temperature of PLA as compared with PET all make successful manufacture and commercialization of acceptable PLA beverage bottles very, very difficult.

With respect to the use of PLA for beverage bottles, the thermal properties of PLA currently present significant challenges to the use of PLA bottles for hot or warm fill applications. Because the barrier properties of PLA are relatively poor compared to PET, PLA is not currently considered a viable material candidate for bottle applications requiring barrier to oxygen ingress or carbon dioxide permeation. Thus, PLA is not currently regarded as a suitable material from which to manufacture bottles for use with carbonated beverages.

One beverage bottle application in which PLA has been attempted, although with only limited success, is for the manufacture of non-carbonated drinking water bottles. But known PLA drinking water bottles have a significant disadvantage. The water vapor transmission rate (“WVTR”) of PLA is significantly higher than that of PET. As a result, after drinking water is filled into a known PLA bottle and the bottle is capped, over time a vacuum is created within the bottle as the water product escapes by permeation through the bottle sidewall faster than N₂ or O₂ can permeate into the bottle. As a result, the sidewall of known PLA drinking water bottles significantly deforms into the bottle. This inward deformation of the bottle side wall in response to vacuum created within the bottle is known as “paneling.” While this phenomenon has been observed in PET drinking water bottles as well, it occurs much quicker in PLA bottles than it does in PET bottles because of the higher water vapor transmission rate of PLA.

FIGS. 1 and 2 illustrate paneling observed in known PLA drinking water bottles. After being filled and capped, as shown in FIG. 1, the body portion of the known PLA bottle has a hollow cylindrical shape with a substantially circular cross section as shown in FIG. 1A. Over time, permeation of water vapor outwardly from the bottle through the PLA bottle material creates a vacuum inside the bottle. As illustrated in FIGS. 2 and 2A, this vacuum causes the walls of the body portion to deform inwardly into the bottle, thereby significantly transforming the shape and overall appearance of the known PLA bottle. It has even been observed that, given enough time, such deformation of known PLA drinking water bottles can result in failure of the PLA walls of the body portion of the bottle, thereby causing water to leak out from the known PLA bottle.

Paneling of known PLA beverage bottles is a significant problem for at least three reasons. First, there is a belief that some consumers may interpret a “paneled” bottle as being of poor quality, and therefore delay or forego their purchase of water in such a paneled bottled. Second, in addition to not presenting a desirable appearance, many consumers are likely to believe that a paneled beverage bottle has been opened and will therefore not purchase drinking water in such a bottle. Third, because product labels on beverage bottles are often printed or affixed on the bottle circumference, paneling often renders the product label difficult or impossible to easily read or to adhere to the bottle.

What is needed in the art is a new beverage bottle that not only overcomes the adverse environmental consequences associated with known PET beverage bottles but also addresses the adverse problems associated with paneling in known PLA beverage bottles. What is also needed in the art is a new method of manufacturing PLA beverage bottles that overcomes the difficulties associated with known methods of manufacturing PLA drinking water bottles.

### SUMMARY OF THE INVENTION

The present invention overcomes problems associated with known PLA beverage bottles by providing a bioresin bottle with a neck having a finish with an opening, an adjacent shoulder, a base capable of supporting the bottle upright, and a main body between the shoulder and base. The main body has a first portion that is substantially circular in cross-section and a second portion that is substantially elliptical in cross-section at a predetermined location. The hoop stiffness of the first portion is greater than the hoop stiffness of the second portion such that when a vacuum is created inside the bottle by the outward permeation of water vapor through the bottle walls, the second portion deforms inwardly to decrease the length of the minor axis and deforms outwardly to increase the length of the major axis. In this way, the shape of the bottle after vacuum-induced deformation is controlled and the resulting bottle after such deformation maintains a shape that is attractive to consumers.

In an embodiment of the present invention, the second portion is capable of deforming outwardly to a point at which the length of the major axis of the substantially elliptical cross section of the second portion is greater than the length of the diameter of the substantially circular cross section of the first portion. In another embodiment, a circumferential rib separates the base from the second portion of the main body and a circumferential rib separates the first portion of the main body from the second portion of the main body. The circumferential rib separating the base from the second portion of the main body and the circumferential rib separating the first portion of said main body from the second portion of said main body may not be parallel.

The first portion of the main body further may have at least one circumferential rib and, advantageously, the second portion of the main body may be free from circumferential ribs. At least one circumferential rib may be a wave-like circumferential rib.

A plurality of longitudinally spaced arcuate projections may extend outwardly from the second portion of the main body to provide localized stiffness at predetermined locations. Advantageously, the second portion of the main body of the bottle may include a first plurality of outwardly extending longitudinally spaced arcuate projections and a second plurality of outwardly extending longitudinally spaced arcuate projections, the second plurality of arcuate projections being separated from the first plurality of arcuate projection by the minor axis of the substantially elliptical cross section of the second portion.

The present invention also provides and advantageous method of making a preform comprising a biodegradable bioresin. The method of making the preform comprises obtaining a bioresin comprising polylactide or polylactic acid, drying the bioresin, injection molding the bioresin in a mold to form a preform having a weight in a range of from 21 g to 23.5 g, preferably 22 g to 23 g. In accordance with the method, the injection pressure is in a range of from about 350 to about 700 bar. The resulting preform is suitable for blow molding a biodegradable bioresin bottle having a main body comprising a substantially circular cross-section and a substantially elliptical cross-section in the main body of the bottle.

In another embodiment of the present invention, the injection molded preform comprises a finish portion, a transition portion, a body portion, and a closed end cap portion for making a blow molded biodegradable bioresin bottle having a body comprising a substantially circular cross-section and a substantially elliptical cross-section in the body of the bottle. The preform comprises polylactic acid or polylactide. The preform, in accordance with the present invention, has a weight in a range of from 21 g to 23.5 g, preferably 22 g to 23 g.

In another embodiment of the present invention, the preform is used to make a biodegradable bioresin bottle comprising polylactic acid or polylactide. The method comprises stretch blow molding a preform comprising polylactic acid or polylactide into a biodegradable bioresin bottle having a main body comprising a substantially circular cross-section and a substantially elliptical cross-section in the main body of the bottle. The preform is suitable to use to make a 500 mL biodegradable bioresin bottle.

In another aspect of the present invention, a method of making a biodegradable bioresin bottle having a finish with a finish ledge and a main body having first and second portions with bottle side walls is provided. In accordance with the method of the present invention, a preform is obtained comprising polylactic acid or polylactide, the preform is heated to a temperature in a range of about 80° C. to 95° C. as measured on the preform above the finish ledge of the preform, and the preform is stretch blow molded in a ratio of preform to bottle such that the side walls of the bottle are molecularly oriented in a portion of the main body of the bottle so as to produce a bottle that deforms in a predetermined location.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, and in which:

FIG. 1 is a perspective view of a known PLA drinking water bottle;

FIG. 1A. is a sectional view of the known PLA drinking water bottle of FIG. 1 taken along the line 1A-1A in FIG. 1;

FIG. 2 is a perspective view of the known PLA drinking water bottle of FIG. 1 that has undergone paneling as a result of vacuum creation inside the bottle;

FIG. 2A. is a sectional view of the known PLA drinking water bottle of FIG. 2 taken along the line 2A-2A in FIG. 1;

FIG. 3 illustrates a typical stress-strain curve for materials that undergo strain hardening;

FIG. 4 is a perspective view of a preform having heat induced deformation in the finish region;

FIG. 5 illustrates an infrared (IR) absorption spectra for PET and PLA materials;

FIG. 6A is a plan view of the base of a bottle in accordance with the present invention;

FIG. 6B is a sectional view of the base illustrated in FIG. 6A taken along the line 6B-6B in FIG. 6A;

FIG. 7 depicts the sensitivity of bottle base weight to preform temperature for PLA and PET bottles;

FIG. 8A is a perspective view of a preform in accordance with the present invention;

FIG. 8B is a longitudinal sectional view of the preform of FIG. 8A;

FIG. 9 is a drawing of a mold suitable for blow molding the preform of FIG. 8A into a biodegradable bioresin bottle;

FIG. 10 is a perspective view of a biodegradable bioresin bottle in accordance with the present invention;

FIG. 11 is a perspective view of a biodegradable bioresin bottle in accordance with the present invention;

FIG. 11A is a perspective view of the bottle of FIG. 11 rotated 90 degrees counterclockwise about its longitudinal axis;

FIG. 11B is a perspective view of the bottle of FIG. 11 rotated 90 degrees clockwise about its longitudinal axis;

FIG. 12A is a sectional view of the bottle of FIG. 10 taken along the line 12A-12A in FIG. 10;

FIG. 12B is a sectional view of the bottle of FIG. 10 taken along the line 12B-12B in FIG. 10; and

FIG. 13 is a sectional view of the bottle of FIG. 10 taken along the line 12B-12B in FIG. 10 after the occurrence of bottle wall deformation in response to vacuum creation inside the bottle.

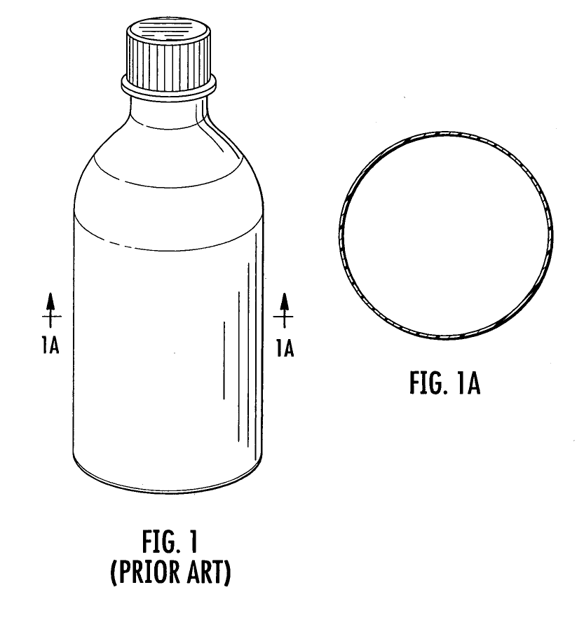

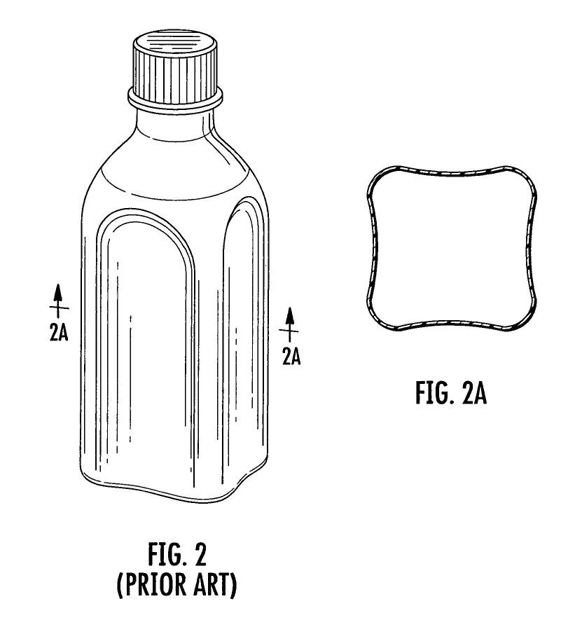

### DETAILED DESCRIPTION OF THE INVENTION

The following detailed description of the embodiment(s) is merely exemplary in nature and is in no way intended to limit the invention, its application, or uses.

A biodegradable material is a material that can be broken down into carbon dioxide (CO₂) and water (H₂O) by microorganisms such as bacteria and fungi. Such materials undergo a significant change in chemical structure during this process, resulting in loss of properties including, but not limited to, molecular weight, structure, strength, and integrity. A compostable material is a biodegradable material that satisfies one or more of the various standards regarding biodegradability, such as rate biodegradation, maximum residue of material left at a specific point in time and a requirement for the material to have no harmful impact on the final compost or the composting process. Commonly used standards for compostable plastic materials are the American standard ASTM D 6400-99, the European standard EN-13432 and DIN V-54900. As set forth in ASTM D 6400-99, such a material is “capable of undergoing biological decomposition in a compost site as part of an available program, such that the plastic is not visually distinguishable and breaks down to carbon dioxide, water, inorganic compounds, and biomass, at a rate consistent with known compostable materials (e.g. cellulose) and leaves no toxic residue.” In accordance with the present invention, a biodegradable and compostable bottle may be created using bioresin material.

Biodegradable materials suitable for use as a bioresin in the present invention include, but are not limited to, polylactic acid or polylactide. Several forms of PLA include, but are not limited to, poly-L-lactide, poly-D-lactide, poly-D, L-lactide, and a combination thereof.

Table 1 below lists PLA's physical and chemical properties, with PET for comparison, to understand the behavior of PLA. Each of these is discussed herein.

TABLE 1

| PROPERTY | PLA | PET |
|---|---|---|
| Density (g/cm³) | | |
| Amorphous | 1.248 | 1.335 |
| Crystalline | 1.290 | 1.450 |
| Resin Bulk Density | 0.79 g/cc | 0.76 g/cc |
| Yellowness Index | 20-60 | −1-3 |
| Melt Temperature (° C.) | 155-175 | 245 |
| | (165-173 | |
| | for | |
| | bottle grade | |
| | PLA) | |
| Glass Transition Temperature (° C.) | 55-60 | 70-79 |
| Crystallization Temperature (° C.) | 100-120 | 120-155 |
| Thermal Conductivity (cal/cm-sec-° C.) | | |
| Amorphous | 3.1 × 10⁻⁴ | 3.6 × 10⁻⁴ |
| Crystalline | 4.5 × 10⁻⁴ | 9.5 × 10⁻⁴ |
| Specific Heat (cal/g° C.) | | |
| Below Tg | 0.29 | 0.29 |
| Above Tg | 0.51 | 0.32 |
| CO₂ Transmission (cc-mil/100 in²/day) | 200 | 19.6 |
| O₂ Transmission (cm³-25 μ/m²/24 hr) | 600 | 140 |
| WVTR (g/pkg/day-atm) | 0.301 | 0.010-0.020 |
| Mechanical Strength - Young's Modulus on | | |
| Oriented Film | | |
| Tensile Yield Stress (MPa) | | |
| Machine Direction | 72 | 275 |
| Cross Direction | 65 | — |

In one aspect of the present invention, the present invention relates to preform designs and the preforms resulting therefrom.

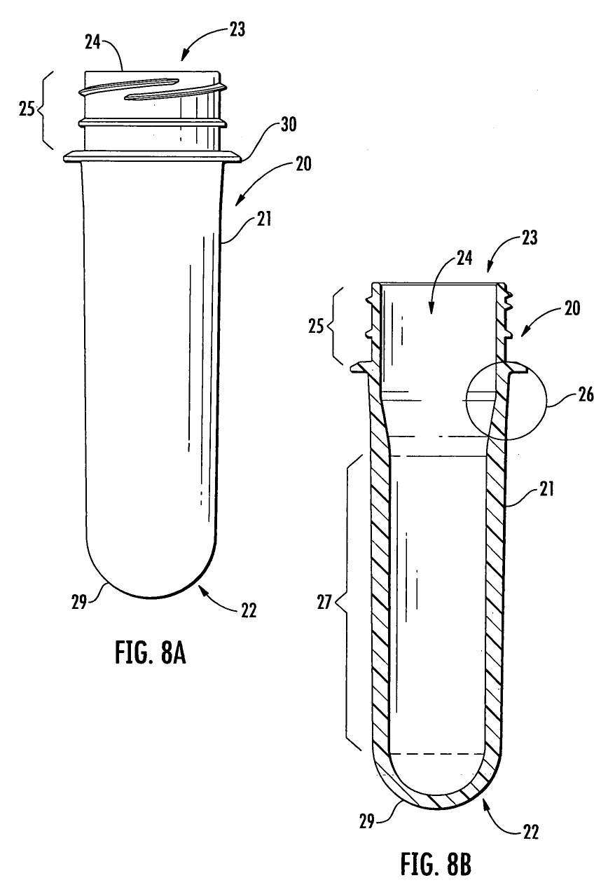

A preform is a polymeric pre-shaped part that is used to make a specific product, which for purposes of the present invention is a biodegradable bioresin bottle. As illustrated in FIGS. 4, 8A and 8b, the preform 20 is a tube-like piece of plastic having a generally cylindrical outer wall 21 connecting a closed end 22 to an open end 23 having an opening 24 through which compressed high pressure gas such as air can pass. The preform 20 comprises a finish portion 25, a transition portion 26, a body 27, and an end cap 29.

In accordance with the present invention, the preform is formed by injection molding. After being formed by injection molding, the preform is quickly quenched in the mold in order to keep the preform amorphous. After manufacture the preform may be packaged for later use or fed into a blow molding machine.

Blow molding is a process by which hollow plastic articles are formed. In the present invention, the method is directed to a blow molding process for manufacturing biodegradable bioresin bottles, more particularly biodegradable bioresin bottles comprising PLA suitable for containing non-carbonated beverages such as water. More particularly, the method of the present invention is directed to what is generally referred to as a “two-stage” or “reheat stretch” blow molding process. In the two-stage blow molding process, the preform is heated above its glass transition temperature, then blown into a bottle using high pressure air using a blow mold. The preform is usually stretched with a core rod as part of the process.

With respect to the preform heating, the preform is typically heated by infrared heaters or lamps. The preforms are passed in front of lamps that emit light in the infrared (IR) region while being cooled with airflow on the outer surface. The lamps are designed to heat the preform from the outside to the inside as the energy emitted penetrates through the preform wall and is absorbed. The ovens in standard blow molding equipment have typically been optimized to heat polyethylene terepthalate (PET) resins as opposed to polylactic acid (PLA) resins. Variances in the IR absorption from that of PET may cause less efficient preform heating. Therefore, reheat rate enhancing additives are often added to the PLA. Examples of reheat rate enhancing additives include, but are not limited to, activated carbon, carbon black, phthalocyanines, 2,3-napthalocyanines, squaraines (squaric acid derivatives), croconic acid derivatives, substituted indanthrones and certain highly substituted anthraquinones, near infrared absorbing dyes or combinations of these with carbon black, antimony metal, tin, copper, silver, gold, palladium platinum, black iron oxide, and the like. Further reheat rate enhancing additives are described in U.S. Pat. No. 6,197,851 and U.S. Pat. No. 7,189,777.

Since PLA is a crystallizable thermoplastic, two different densities are reported—an amorphous density and crystalline density. The amorphous density represents the PLA density in its amorphous state, such as preforms or the un-oriented bottle finish area. The crystalline density shown represents the density of a 100% crystalline PLA. PLA has a density lower than PET; thus, if using existing PET tooling, the ratio of the densities should be multiplied by the PET preform weight to estimate the PLA preform weight. The degree of crystallinity impacts the material properties and performance. In the preform molding, the PLA material is cooled quickly to prevent thermal crystallization from occurring. Thus, if molded properly, PLA preforms are highly amorphous and clear. Crystals formed through thermal crystallization are larger than the wavelength of light, thus when present can cause visible light to scatter producing haze in the molded part. In addition, thermal crystallinity results in more rigid or brittle areas in the preform which, when reheated during blow molding, further crystallize causing blow-outs.

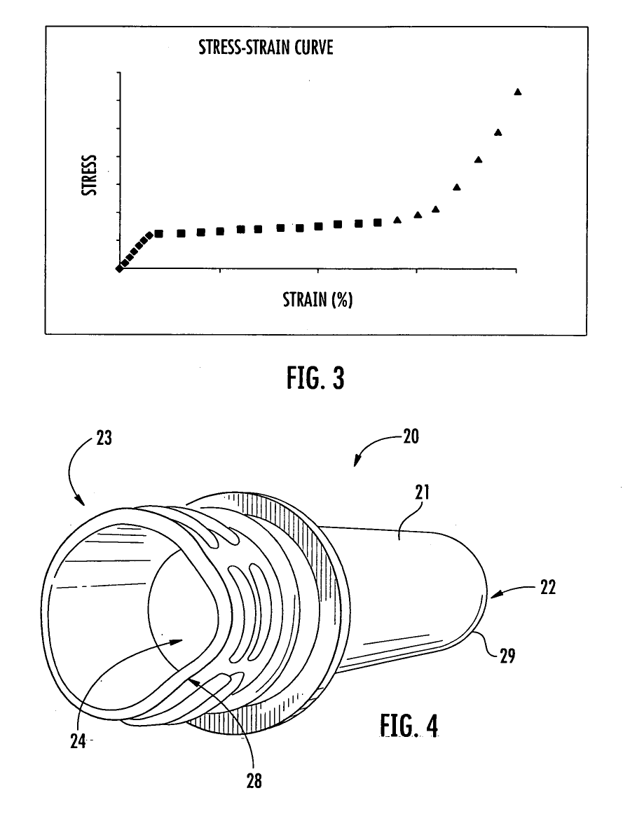

Similar to PET, stretch orientation in PLA causes strain-induced crystallinity to occur which creates oriented and transparent crystals with significantly improved mechanical properties. In bottle blow molding, the final bottle sidewall crystallinity is in the 35-45% range. FIG. 3 illustrates a typical stress-strain curve for materials which undergo strain hardening. There are three distinct regions of such curve—an initial region in which the material easily stretches as force is applied but is recoverable; a plateau region where permanent stretching, chain deformation and crystal growth occurs and then a strain hardening region, shown as the triangles, in which the material is over-stretched. During the stretching process, the material will yield to the forces applied as the preform expands. However, it will reach a point at which the force required to further move the material increases dramatically. As the PLA stretches, the strain induced crystallinity increases within the amorphous regions of the polymer and improves the polymer's mechanical properties. For PET, the mechanical strength of the oriented material prevents it from further stretch if force is continually applied after complete strain-hardening occurs. PLA, however, has lower mechanical strength and continues to yield until the bottle sidewall becomes too thin and ruptures.

PLA crystallinity is evaluated using a first heat only Differential Scanning Calorimetry (DSC) method. The level of crystallinity is determined by the ratio of the sample heat of fusion to the 100% crystalline PLA heat of fusion (ΔHm), 93 J/g. A well-oriented PLA bottle has a ΔHm of 35-45 J/g. Through X-ray diffraction studies, it is believed that 45% quiescent crystallization is the maximum that can be achieved. As a bottle development and quality tool, crystallinity measurements ensure that blow molding orientation is sufficient to maximize bottle properties and aid in the understanding of preform processing and quality issues.

Resin bulk density for PLA is comparable to PET, which would indicate that bulk handling systems such as air transfer lines should handle both materials. PLA resin pellets typically appear slightly yellow in color and spherical with smooth, rounded edges from the under-water pelletization through which they are formed. The pellet diameter typically ranges from about 3 mm to about 3.5 mm. The difference in pellet geometry from PET pellets, which are smaller in diameter and strand-cut with sharp edges, may require slight adjustments to conveying lines when changing from one pellet geometry to another. For dedicated PLA systems, however, this difference would not be of concern. The melt temperature for PLA is about 155° C. to 175° C., depending upon the copolymer content and molecular weight. When running on existing PET equipment, all transfer lines, dryers, hoppers, and any equipment in contact with the PLA resin should be thoroughly cleaned to remove all PET. Any PET remaining that enters the injection feed throat becomes an un-melted contaminant in the PLA molding. PLA preforms containing PET that are blow molded results in blowouts as PET's T_{g} is significantly higher. Regarding permeation characteristics, PLA has increased permeation to non-polar gases and water when compared to oriented PET. Since the barrier properties of PLA are relatively poor compared to PET, PLA is not currently considered a suitable material candidate for applications requiring barrier to oxygen ingress or carbon dioxide permeation. The bottle of the present invention takes into consideration the vacuum that occurs as the water product escapes by permeation through the bottle sidewall faster than N₂ or O₂ can permeate into the bottle. PLA improves in mechanical properties through stretch orientation due to the strain hardening that occurs. The PLA bottles, however, have lower Young's modulus when compared to PET, and are not able to withstand pressurization even when blown producing high levels of strain induced crystallization without excessive creep. The thermal, barrier and mechanical properties of PLA are currently thought to limit commercial applications for PLA requiring significant pressurized containers and certain hot fill bottle applications.

Blow molding PLA preforms into a warm or hotter mold can help relieve molded-in stresses caused by the bottle blow molding process, but does not build sufficient thermal stability for hot filling or elevated bottle storage temperatures. It has been reported that both preforms and bottles deform under elevated temperatures. When stored in hot and humid warehousing conditions of 120° F. and at least 50% RH for 1 week, PLA preforms, especially those exposed to the weight of other preforms above within the gaylord, distort in the thinner finish area. FIG. 4 illustrates an example of a preform 20 tested under these conditions, with the resulting finish deformation indicated at reference numeral 28. Due to the severity of the finish distortion, such preforms can no longer be blow molded as they no longer fit on blow molding spindles. Proper management of preform storage and shipping conditions can reduce or eliminate this problem. PLA bottles shrink similarly to PET bottles when exposed to 100° F. temperatures, but such shrinkage increases dramatically as the temperature increases beyond about 120° F. to about 140° F. due to PLA's lower T_{g}.

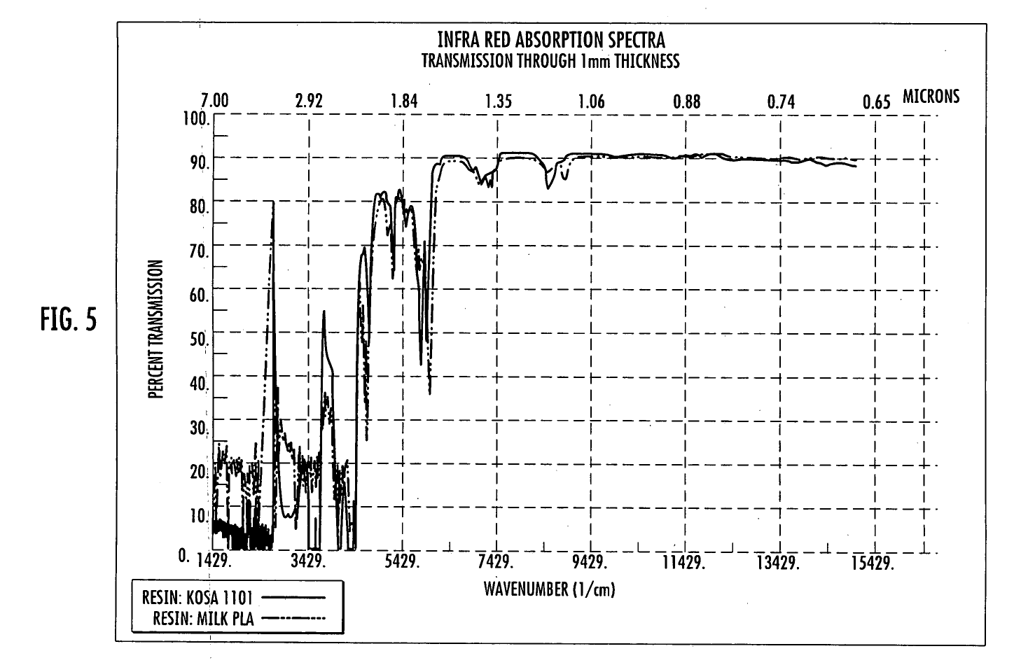

In drop impact testing, PLA bottles have been shown to perform adequately when the material is well-oriented within the base area. Another characteristic of PLA that is relevant for two stage bottle blow molding is the IR absorption spectra. During the preform heating in the blow molding process, the PLA preforms are passed in front of lamps that emit light in the IR region while being cooled with airflow on the outer surface. The lamps are designed to heat the preform from the outside to the inside as the energy emitted penetrates through the preform wall and is absorbed. The ovens in standard blow molding equipment have been optimized to heat PET resins efficiently. Variances in the IR absorption from that of PET may cause less efficient preform heating, unless this is compensated for by the addition of reheat additives to the PLA. The IR absorption spectra for standard PET and PLA materials are shown in FIG. 5 and show slight differences in the IR absorption in the 1400 to 5000 (1/cm) wavenumber region. Since the reheating rate is important for PLA preforms to maintain high blow molding rates, several reheat additives have been manufactured to allow for better infrared absorption resulting in more efficient IR heating as discussed previously herein. They are commonly used for two-stage PLA bottle manufacturing, as opposed to re-designing the blow molding oven to achieve preform heating, so that PLA bottles can be produced on existing, standard equipment.

While PLA may not have the physical attributes that PET has for many rigid container applications, PLA continues to see high interest as a replacement material for PET in some applications. As a material, it offers superb clarity. In stark contrast to PET, it provides great definition when blown into bottles with decorations such as logos or features that have sharp radii. Some of the properties that may have limited widespread commercial adoption of PLA as a replacement material for PET in the market are PLA's poorer gas barrier characteristics, impact properties and lower thermal deformation temperature.

There are design considerations associated with PLA with both the molded article and tooling design. The preform is an integral part of achieving acceptable bottle clarity, performance, and consistency. As with PET preform design, there is a range of stretch ratios that achieve an acceptable bottle distribution and are discussed in more detail herein. Preforms and bottle combinations below the lower end of both axial and radial stretch ratio tend to form bands of thicker material in the bottle sidewall that cannot be eliminated through blow molding processing. Above the upper end of the stretch ratio limits, the preform becomes overstretched during the blow molding process and creates stress whitening or pearlescence in the final bottle. Other preform design considerations are the neck diameter and neck to bottle opening.

PLA preforms shrink slightly during the reheating process, causing the preform diameter to increase and the overall length to decrease. As a result, if employed, the blow mold top plate is designed with higher clearance between the as-molded PLA preform and top plate diameter to ensure sufficient clearance between the preform neck and mold during blow molding. Checking preforms for their shrinkage levels during injection molding can be used as a quality tool.

The preform end cap thickness is generally thinner than the preform wall thickness to prevent excess material in the base area during blow molding. For the inside dimensions, preform shrinkages of 0.005 inch/1 inch on preform diameters and 0.008 inch/1 inch on preform lengths are applied to the plastic print to design the injection mold tooling. On the outer dimensions, shrinkages of 0.011 inch/1 inch and 0.008 inch/1 inch are applied to the preform diameter and length, respectively. For example, to produce the plastic dimension of 1 mm, the tooling is manufactured to a dimension of 1 mm×1.005 mm/mm. Another consideration for PLA preform design is to avoid sharp transitions from thick to thin sections as this may produce stress-whitening in the bottle blow molding.

From an injection molding tooling standpoint, injection mold tooling should be polished on both the core and cavity to prevent drag lines or marks in the preform that create visual bottle defects. Hardened stainless steel is commonly used in production tooling. PLA has successfully been molded on hot-runner systems designed for PET, though as discussed below, care must be taken to eliminate all PET from the hot runner system. In the preform tooling design, consideration should be given to allow maximum water cooling to the core rod and cavity because PLA's higher heat capacity and lower thermal conductivity impede heat transfer from the plastic to the mold. Preforms ejected from the mold should be sufficiently cooled to prevent deformation as they are transferred into a gaylord.

In addition to the preform/bottle relationship, other important characteristics for making the bottle of the present invention include the mold venting and base design. For blow molding design, it has been established that PLA blows into contours and details very well giving better definition than PET would allow. From a mold design standpoint, the air vents and mold parting lines should be minimized so these areas are not accentuated due to the flowing nature of this material. The air vent diameters generally used for PLA are half the size of those found in a typical PET mold.

The blow molds used in accordance with the present invention have smaller pin vents in the base area to prevent the material from flowing into the pin vent area. The bottle face vents for a bottle mold to produce a bottle having substantially circular and substantially elliptical cross-sections in the main body of the bottle as in the present invention were vented through a parting line with a face vent that was 0.003 inches to prevent material from flowing into this vent. Pin vents are not required in the base or bottle sidewall for the bottle having an oval and round cross-sections. A bottle mold with no pin vents in either the base or bottle sidewall is not uncommon for polypropylene or PLA containers as these materials tend to flow into any mold details and would be aesthetically unacceptable with pin vents or on bottle designs that do not need the venting in order to fully blow into the bottle mold.

As discussed above, PLA resin is typically supplied as a crystallized pellet. Since the material degrades at melt temperatures in the presence of moisture, PLA pellets should be stored under conditions that minimize temperature and humidity exposure and prevent moisture absorption. PLA resin is typically supplied in gaylord cartons or super sacks which are sealed to prevent moisture absorption. Once transferred into bulk handling systems, such as silos or hoppers, the PLA resin may be purged with dry air or nitrogen to minimize moisture gain. Unopened containers are often allowed to equilibrate prior to opening when transferring material from a cold environment to prevent condensation of moisture on the pellets. As PLA is a hygroscopic material, it should be dried prior to melt processing to minimize degradation and loss in molecular weight. If not properly dried, PLA may produce hazy, poor quality preforms or unacceptable bottles. The material should be dried to a moisture level below 100 ppm moisture to prevent adverse effects on the PLA. Karl Fischer method or a gravimetric moisture analyzer may be used to confirm that the moisture level is acceptable. For processing with unusually long melt residence time or melt temperatures above 240° C., PLA is often dried further to a moisture level below 50 ppm to ensure molecular weight retention and stability. After opening, any PLA resin containers are typically sealed to prevent moisture gain.

The PLA resin can be dried in standard desiccant bed dryers commonly used for PET drying. In dryers with a regeneration cycle between desiccant beds, care must be taken to ensure that the resin pellets do not experience a spike in temperature as the dryer cycles from one desiccant bed to the other. If a spike in temperature in excess of 150° C. is experienced, the PLA resin pellets may melt due to the excessive heat causing bridging or blocking air flow around the dryer cone. The drying conditions set forth in Table 2 below may suitably be used with the present invention.

TABLE 2

| | Recommended | |
|---|---|---|
| Drying Parameter | Settings | |
| Residence Time (hours) | 4 | |
| Air Temperature ° F. (° C.) | 212 | (100) |
| Air Dew Point ° F. (° C.) | −30 | (−35) |
| Air Flow Rate, CFM/lb resin (m³/hr-kg | >0.5 | (1.85) |
| resin) | | |

Once dried, the resin should be transferred to the injection molding system through sealed transfer lines. Jacketing or nitrogen purging of transfer lines is recommended, but not necessary. Dedicated transfer lines for PLA are preferred to prevent cross-contamination with PET fines that can accumulate in the transfer lines or dryer. As mentioned above, when running on existing PET equipment, the dryer and all transfer lines are thoroughly cleaned to remove PET pellets, angel hair, and fines. Any PET that transfers into the injection molding equipment may create an un-melted contaminant when molded into the preforms.

A suitable PET purging process may be accomplished by running a compound such as polypropylene or polyethylene through the entire injection system, at the current resin's operating temperatures for at least 30 minutes. Advantageously, higher viscosity polypropylene may be initially used in the purge process and then followed by use of a lower viscosity polypropylene as the temperature is decreased to improve purging effectiveness. System temperature is then decreased to PLA melt temperature and PLA is then introduced into the molder at its recommended operating temperatures until the PLA purge becomes clear. If polypropylene is not available a typical purging compound may also produce satisfactory results. Molding machines with shooting pots may take longer to purge then conventional molding machines because of the increased areas in which resin can “hang up” or accumulate. Upon shutdown or changeover to another material, the molding equipment should again be purged with polypropylene to remove any residual PLA.

To augment preform heating during the blow molding process, IR reheat additives may be incorporated into the preform in the injection molding step. Color concentrates or liquid colorants can be incorporated into the PLA resin preforms at a letdown ratio. In such production systems, the liquid colorant is fed into the throat of the injection molding press using a liquid color pump that is calibrated to deliver at the desired let-down ratio. PLA is typically melt processed with general purpose or barrier-type screws to produce preforms suitable for blow molding. Injection molding problems encountered in the past have included the hot runner tips pulling off, splay, swirl in the endcap, and preform shrinkage upon reheat.

Table 3 below lists the injection molding conditions used as a starting point for process optimization. Similar conditions were used to injection mold a 22.4 g preform with a finish that is referred to in the industry by the Closure Manufacturers Association as a PCF-26P-1, Voluntary Standard Flat Water Finish (“26P”) finish, in accordance with the present invention. If the unit cavity prototype tool has only in-mold cooling, the cycle time is significantly longer than would be expected on production equipment.

TABLE 3

| | |
|---|---|
| Barrel Temperatures (° C.) | 210-220 |
| Mold Temperature (° C.) | 23-25 |
| Nozzle Temperature (° C.) | 210-220 |
| Injection Pressure (bar) | 350-700 |
| Injection Speed (ccm/s) | 12.0 |
| Circumferential Screw Speed (m/min) | 10.0-25.0 |
| Back Pressure (bar) | 10-25 |
| Cycle Time (sec) | 27.0-27.5 |

PLA preforms should be clear, with no haze or visible contaminants. Good preform concentricity less than 0.005 inches is important to produce even radial material distribution in the bottle. PLA can also be analyzed for molded-in stresses using the cross-polarized lights. It is important to minimize molded-in stress as the preforms shrink during the reheating process to relieve any molded-in stress. This shrinking causes dimensional changes in the PLA preform that impacts its fit into the blow mold neck plate and affects the stretch ratio between preform and bottle. PLA preforms may also craze as they shrink upon reheating and form waves or ridges that will blow out in the well-oriented sections, but show as visual defects in the un-oriented sections. For this reason, injection molding conditions should be optimized as much as possible to minimize molded-in stress. A quick quality tool used to evaluate the molded-in stresses is to evaluate the preform appearance under cross-polarized lighting. The process can be adjusted to minimize the appearance of differential stress patterns that appear under cross-polarized lights. Another tool for measuring preform molded-in stress is to measure the preform before and after immersing the preform in 180° C. to 185° C. water for one minute. The preform shrinkage under this condition should not exceed 4%. During extended runs, plate-out of lactide may occur in the form of a very fine powder deposit on the tooling. This can be removed with a soft cloth routinely during the injection molding. Plate-out may also occur if injection speeds are too low, and or mold temperature is too cold, or machine shut-down causes excessively long melt residence time.

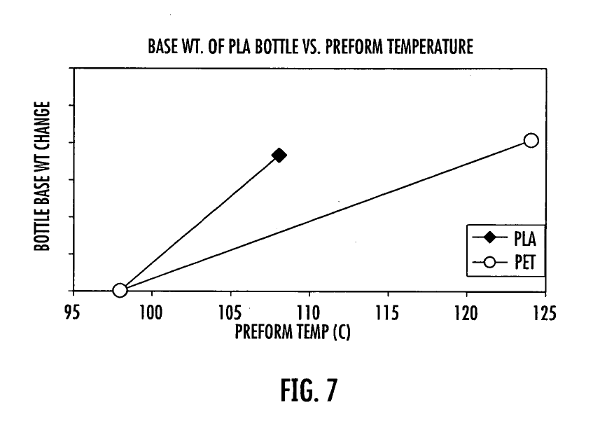

The second step in producing a bottle through two-stage blow molding after the step of heating the preform is to inflate the preform into a mold. The manner in which the preforms are heated impacts bottle clarity and material distribution. The preform heating should be optimized to achieve an even sidewall distribution of material and highly oriented base. Preform temperatures for PLA preforms after heating range from 85° C. to 95° C., depending upon the point of measurement and preform to bottle matchup. Unlike PET which can generally be processed over a range of 15° C. to 20° C., the processing window for PLA for a given preform and bottle combination is typically significantly smaller in the 5° C. range. As the preform temperature increases, the bottle base weight will increase significantly similarly to PET. At the lower end of the preform temperature, the bottle has pearlescence or blow out during the blow molding process. For a given preform and bottle combination, the blow molding window is determined by varying the overall oven power input to determine the upper and lower limits. FIG. 7 illustrates the sensitivity of bottle base weight to preform temperature for PET and PLA. As illustrated, for PLA a slight change in preform temperature can result in a significant change in the base weight of the resulting bottle. As discussed above, the preforms are heated in the blow molding oven using infrared heaters. Thus, the outside wall is heated first and as the energy penetrates through the wall, the inside of the preform becomes heated. As the inside of the preform must stretch significantly farther during the blow molding process, this must be sufficiently heated to avoid blowouts or haze in the bottle. The soak time for the preforms between ovens is important to allow the heat to equilibrate throughout the preform wall. This soak time is dependent upon wall thickness of the preform. Another consideration during PLA blow molding is to limit the time between preform transfer from the oven into the blow mold and where possible, ensure that this time is consistent among all blow molding cavities. Differences in this dwell time between oven and blow molding can lead to inconsistent bottle material distribution and quality.

The air pressures required to blow mold PLA are typically lower than those used for PET, but must be optimized for a given preform and bottle combination.

Because PLA strain hardens earlier than PET, stretching speeds and timing are slightly different with earlier stretching used for PLA. Stretching speeds of 1.2 m/s to 2.0 m/s have been successfully used to produce acceptable PLA bottles. The bottle mold temperature is generally warm while the base mold is cooled to 40° F. to quickly cool that area. Due to the lower Tg of PLA, the bottle cooling should be optimized to ensure that the bottle dimensions meet specifications. Excess amorphous material remaining in the base will remain pliable after exiting the blow mold. This material may deform because the material remains above Tg after exiting the blow mold. Additional mold cooling, such as air jets, may be incorporated to quickly cool and harden this center base area. As discussed above, the base design can also be adjusted to facilitate more stretch orientation in the base area and prevent excessive material there. As the bottle is removed from the blow mold, if the base is too pliable, it will snap back causing the base to bulge outwardly or can stick onto the base mold carrier and prevent the bottle from being removed from the blow mold. Thus, the base mold design and cooling are important considerations. Blow molding considerations are listed in Table 4 below to assist in the optimization process.

TABLE 4
Parameter Setting

| Parameter | Setting |
|---|---|
| Low Pressure | Minimize |
| High Pressure | Minimum that produces acceptable bottle |
| Mold Temp (° F.) | 70-100 |
| Base Mold Temp. (° F.) | 40 |
| Preform Temp. (° C.) | 80-95 |

Exposure to high temperatures and humidity during shipping adversely affect bottle dimensional stability and permeation. The recommended storage temperature of the bottle is below about 105° F. However, this is not always possible given the high temperatures experienced during shipping and warehouse storage.

Preform

FIG. 8A illustrates a preform 20 in accordance with the present invention. FIG. 8B illustrates a longitudinal sectional view of the preform 20 of FIG. 8A in accordance with the present invention.

As shown in FIG. 8A, a preform 20 comprises a finish portion 25, a transition portion 26, a body 27, and an end cap 29. The finish portion 25 of the preform 20 comprises threads, referred to as the “finish,” and what is referred to as the “finish ledge” 30. The transition portion 26 of the preform 20 comprises the portion between the finish ledge 30 of the finish portion 25 and the body 27 of the preform 20. The body 27 of the preform 20 comprises the portion of the preform between the transition portion 26 of the preform 20 and the end cap 29 of the preform 20. The end cap 29 of the preform 20 is positioned at the closed end 22 of the preform 20.

A preform 20 suitable for blow molding a 500 mL biodegradable bioresin bottle in accordance with the present invention has a preform weight in the range of 21 to 23.5 g, preferably 22 g to 23 g. Inventors of the present application believe that it may be possible with continued further effort to create a suitable PLA preform having a lower weight than 21 g but still be within the scope of the present invention.

In accordance with the present invention, the finish portion 25 of a 22 g to 23 g preform preferably has an inside diameter of between about 21 mm and about 22.5 mm, more preferably about 21.5 mm to about 22 mm. The finish ledge 30 of a 22 g to 23 g preform preferably has an external diameter of about 31 mm to about 32.5 mm, more preferably about 31.5 mm to about 32 mm. The finish portion 25 of a 22 g to 23 g preform to the finish ledge 30 preferably has a length of about 16.5 mm to about 17.5 mm, more preferably between about 16.9 mm to 17.2 mm. Preferably, the finish is a 26P (Standard Flat Water Finish) as is known in the industry.

The transition portion 26 of the preform 20 also has a preform wall thickness that varies along its length. For a preform 20 having a weight range of 22 g to 23 g, the wall thickness in the transition portion 26 of the preform 20 ranges from about 1.5 mm to about 3.5 mm, more preferably from about 2 mm to about 3 mm, with the thinnest wall thickness of the transition portion 26 being adjacent the finish ledge 30.

The transition portion 26 of the preform 20 also has an inner diameter that varies across its length. In accordance with the present invention, the inner diameter of the transition portion 26 of a 22 g to 23 g preform preferably ranges from about 21 mm to about 22 mm, more preferably 21.5 mm to 22 mm, at its widest diameter to about 18 to about 19 mm, more preferably 18 mm to 18.5 mm, at its narrowest diameter. The larger inner diameter is nearer the finish. The length of the transition portion 26 of a 22 g to 23 g preform is preferably about 13.5 to about 14.5 mm. The transition portion 26 of a 22 g to 23 g preform preferably has an external diameter that varies along its length ranging from about 25 mm to about 26 mm at its widest diameter, to about 23.5 mm to 24.5 mm at its narrowest diameter.

In accordance with the present invention, the body 27 of a 22 g to 23 g preform 20 preferably has an inner diameter of about 18 mm to about 19 mm, more preferably about 18 mm to about 18.5 mm. The length of the body 27 of a 22 g to 23 g preform is from about 57 mm to about 58 mm. The body 27 of a 22 g to 23 g preform preferably has an external diameter that ranges from about 23.5 mm to about 24.5 mm. The body 27 of a 22 g to 23 g preform has a wall thickness in a range of from about 2 mm to about 3 mm, more preferably from about 2.5 mm to about 3 mm.

The end cap 29 of an a 22 g to 23 g preform preferably has an inner diameter of about 17 mm to about 18 mm, more preferably about 17.5 mm to about 18 mm. The end cap 29 of the preform preferably has a length of from about 11 mm to about 12 mm. The end cap 29 of a 22 g to 23 g preform has an external diameter in the range of from about 23 mm to 24 mm. The end cap 29 has a wall thickness at the closed portion of the end cap in a range of about 2 mm to about 3 mm, more preferably from about 2 mm to about 2.5 mm. In the preform 20 of the present invention, the preform end cap thickness is generally thinner than the preform body wall thickness to prevent excess material in the base area during blow molding. For a 22 g to 23 g preform, the ratio of the wall thickness of the body 27 of the preform 20 to the wall thickness of the closed end cap 29 is in a ratio of from about 1:0.70 to about 1:0.80.

In the present invention, the preform 20 is injection molded and subsequently blow molded into a biodegradable bioresin bottle having a desired configuration and polymeric material weight distribution. The biodegradable bioresin bottle of the present invention is particularly suited for non-carbonated beverages such as water.

A feature of the preform 20 of the present invention is that it is configured to avoid sharp transitions from thick to thin wall sections as this may produce stress-whitening in the bottle blow molding process. These preform features are particularly important to achieve bottle clarity, performance, and consistency, which is especially difficult to achieve in a biodegradable resin bottle, particularly a biodegradable resin bottle comprising PLA.

Another feature that is an improvement over existing biodegradable resin preforms is that the preform designs of the present invention account for the shrinkage factor associated with PLA. PLA preforms shrink slightly, during the reheating process, causing the preform diameter to increase and the overall length to decrease. For the inside dimensions, preform shrinkages of 0.005 inch/1 inch on preform inner diameter and 0.008 inch/1 inch on preform length are applied to the plastic print to design the injection mold tooling. For example, to produce the plastic dimension of 1 mm tooling is manufactured to a dimension of 1 mm×1.005 mm/mm. On the outer dimensions, shrinkages of 0.011 inch/1 inch are applied to the preform outer diameter and 0.008 inch/1 inch are applied to the preform length.

From an injection molding tooling standpoint, injection mold tooling is polished on both the core and the cavity to prevent drag lines or marks in the preform as to prevent visual bottle defects.

Blow Molding

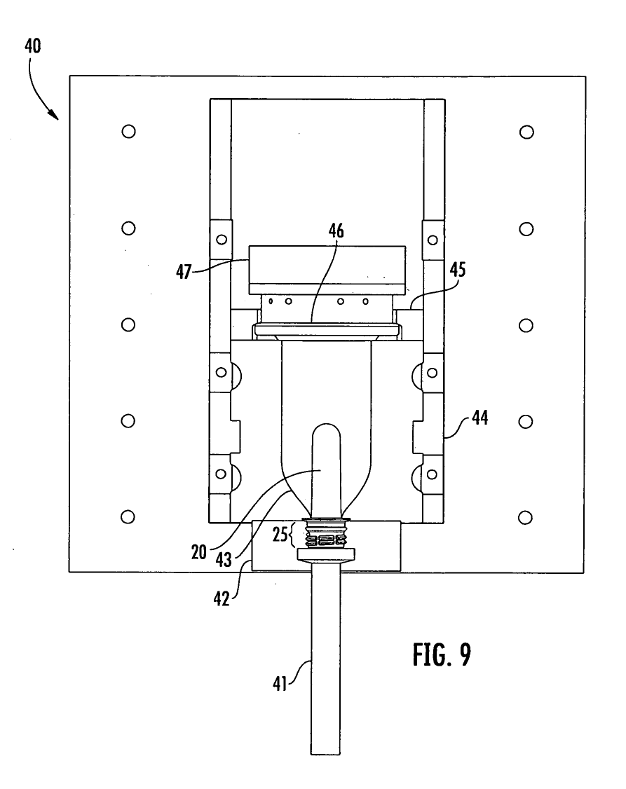

Referring to the figures, FIG. 9 illustrates a suitable blow mold 40 for blow molding a biodegradable bioresin bottle in accordance with the present invention. The blow mold 40 generally comprises a blow mold mandrel 41, a finish protection insert 42, a blow mold cavity 43, a mold carrier 44, a locking ring 45, a base insert 46, a preform 20, and a base adapter 47.

To address the problem associated with shrinkage, if a blow mold top plate is used (not shown in FIG. 9), it is designed to have enough clearance between the PLA preform after it is heated in the oven and the top plate diameter to ensure sufficient clearance between the preform neck and the mold during the blow molding.

Blowouts of PLA material refer to small spikes coming out of the bottle sidewall with a hole in the center. To avoid problems associated with blow outs of the PLA material, pin vents, mold seams and/or parting lines must be minimized so that these areas are not accentuated due to the flowing nature of PLA. The molds to produce a biodegradable bioresin bottle in accordance with the present invention have face vents at the parting lines of the bottle mold. For example, the bottle face vents, the molds are vented through the parting line with a face vent that is about 0.003 inches to prevent material from flowing into this vent. Pin vents are not required in the base or the bottle sidewall for the biodegradable bioresin bottle of the present invention.

In another aspect of the method of the present invention, the preform is stretch blow molded to molecularly orient the side walls of the bottle. The side walls of the bottle are preferably stretch blow molded to molecularly orient a predetermined location of the bottle, more preferably the second portion of the main body to be discussed herein. The oriented side walls of the bottle are generally thinner than the molecularly unoriented regions of the walls. The desired orientation is achieved by stretching the preform during blow molding in a ratio of preform to bottle so as to provide a bottle that deforms in a predetermined location.

Biodegradable Bioresin Bottle

The various portions of a container such as a plastic drinking water bottle may generally be described using the following terminology. The “base” is the bottom portion of a bottle. When a bottle is placed upright on a surface, the base is that portion of the bottle in contact with the surface. The body or “main body” of a bottle is the principal portion of the bottle, usually the largest portion of a bottle. The “shoulder” is the portion of a bottle in which the cross section area of the body decreases to join the neck. In other words, the shoulder is the sloped area of a bottle between the main body and the neck. The “neck” is that portion of a bottle where the shoulder cross section area decreases to form the “finish.” The “finish” refers to a configuration or opening of a bottle that is shaped to accommodate a specific closure. The finish is the portion of the neck having threads, lugs or friction fit members to which a closure is applied. A bottle, therefore, may generally be described from top to bottom as having a finish (which is part of the neck), a shoulder, a main body and a base.

With respect to terminology used herein, the “longitudinal axis” of a bottle refers to an imaginary axis connecting the center of the opening of the finish and the center of the base of the bottle. Thus, when the bottle is positioned upright on its base on a horizontal surface, the longitudinal axis of the bottle is oriented generally vertically. “Inward” as used herein refers to a direction of travel or path toward the inside of a bottle; “outward” as used herein refers to a direction of travel or path away from the inside of the bottle. A “rib” is a continuous indentation toward the inside of a bottle. As used herein, a “circumferential rib” is a rib that is continuous around the entire circumference of a bottle.

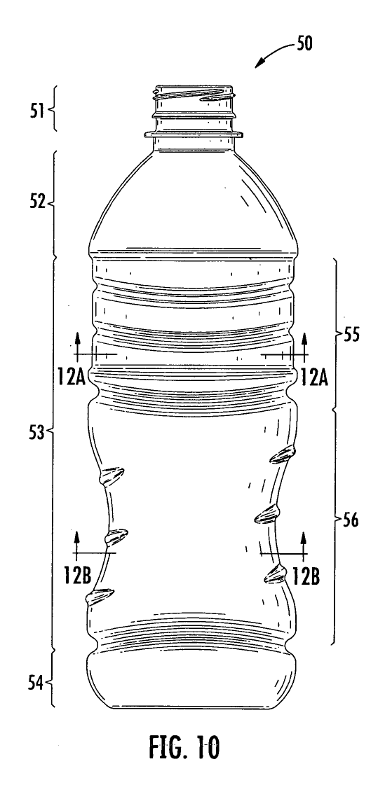

The present invention provides a biodegradable bioresin bottle that overcomes the problem of unacceptably significant paneling in known PLA beverage bottles caused by the high water vapor transmission rate of PLA. Turning now to FIG. 10, a biodegradable bioresin bottle 50 in accordance with an embodiment of the present invention includes a finish 51, a shoulder 52, a main body 53 and a base 54. Advantageously, the finish 51 may be a 26P (“Standard Flat Water Finish”).

The main body 53 comprises a first portion 55 and a second portion 56. Advantageously, the cross sectional shape of the first portion 55 of the main body 53 may differ from the cross sectional shape of the second portion 56 of the main body 53. For example, as illustrated in FIGS. 12A and 12B, the cross sectional shape of the first portion 55 of the main body 53 may be substantially circular (as shown in FIG. 12A) and the cross sectional shape of the second portion 56 of the main body 53 may be substantially elliptical (as shown in FIG. 12B). The cross sectional shape of the first portion 55 of the main body 53 thus has a diameter d and the cross sectional shape of the second portion 56 of the main body 53 has a major axis A₁ and a minor axis A₂.

It has been found that a bottle having a base above zero to about 22 mm, a second portion of the main body height of from about 22 mm to about 100 mm, a first portion of the main body a height of from about 100 mm to about 150 mm and a shoulder height of from about 150 mm to the location of the ledge of the finish may be suitably used in accordance with the present invention. The height of the finish depends upon the dimensions of the finish selected.

It has been found that a bottle having a shoulder 52 of largest width at the position where it meets the first portion 55 of the main body may be advantageously used in accordance with the present invention. From that location, the width of the bottle decreases between the shoulder 52 and the first portion 55 of the main body by a ratio of about 1:0.96. The width then increases where the first portion 55 meets the second portion 56 of the main body by a ratio of about 1:1.04. Preferably, the width of the bottle where the shoulder 52 meets the first portion 55 is the same as the width where the first portion 55 meets the second portion 56. In the case of a circular cross-section, the width is the diameter.

In the second portion 56, the cross-sectional area of the elliptical cross section decreases until reaching its narrowest point, typically near the longitudinal midpoint of the second portion 56, and then increases until meeting the base. The cross-section of the bottle at the pinch point is substantially elliptical as opposed to circular. The ratio of the minimum diameter of the second portion to the maximum diameter of the second portion is about 0.8:1. Preferably, the width of the base (which is the diameter since the base has a substantially circular cross-section) is the same as the width of the shoulder of the bottle and the first portion of the bottle at their respective widest points.

In accordance with the present invention, for an about 22 g to 23 g preform, the diameter of the base at its widest point is from about 67.5 mm to about 68.5 mm. The length of the major axis A₁ of the second portion of the main body at its widest point is from about 67.5 mm to about 68.5 mm. The diameter of the shoulder of the bottle at its widest point is from about 67.5 mm to about 68.5 mm. The diameter of the first portion varies between about 67.5 mm to about 68.5 mm, to about 65 mm to about 66 mm along the height of the bottle. The length of the minor axis A₂ of the second potion at its narrowest point in the second portion is in a range from about 53.5 mm to about 54.5 mm.

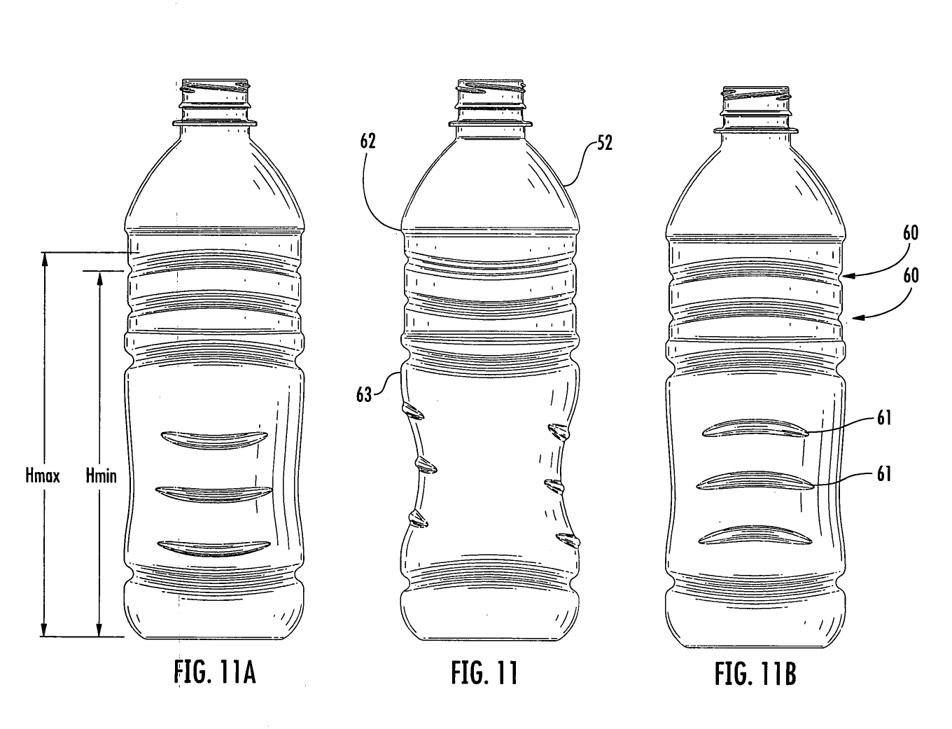

In a preferred embodiment, one or more circumferential ribs 60 are located on the first portion 55 of the main body 53 and no circumferential ribs are located on the second portion 56 of the main body 53. Advantageously, circumferential ribs 60 located on the first portion 55 of the main body 53 may be “wave-like circumferential ribs,” meaning that the height of the rib above the lowest portion of the base varies at different circumferential positions between a maximum height and a minimum height. For example, in FIG. 11A the uppermost circumferential rib is a wave-like circumferential rib that varies in height along the circumference of the bottle between a maximum height Hₘₐₓ and a minimum height Hₘᵢₙ.

The diameter of the shoulder 52 at the position 62 where the shoulder meets the first portion of the main body 55 may be substantially equal to the diameter of the second portion of the main body 56 at the position 63 where the second portion of the main body meets the first portion of the main body, and both of these diameters may be greater than the diameter of the first portion of the main body. In this way, a label placed circumferentially around the first portion of the main body will be prevented from rubbing against adjacent bottles or surfaces.

As illustrated in FIGS. 11, 11A and 11B, one or more arcuate projections 61 may extend outwardly from the second portion 56 of the main body 53. Groups of spaced arcuate projections may be positioned at opposite ends of the minor axis A₂ (as best illustrated in FIG. 11, and “face” concave upwardly (as illustrated in FIG. 11A) or concave downwardly (as illustrated in FIG. 11B) or both. [00107] It has been found that PLA bottles have a tendency to deflect in the amorphous base region if the PLA material is not adequately stretched or cooled during bottle production. Base sagging or deflection can result in a performance and aesthetic concern and in addition could cause volumetric fluctuations during the bottle filling.

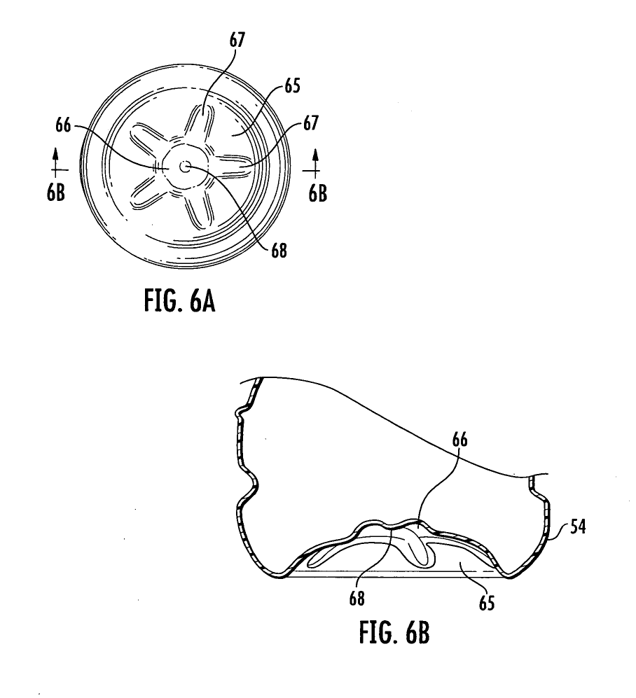

Turning to FIGS. 6A and 6B, the present invention addresses this tendency by providing a base design in which a first generally semicircular “pushup” region 65 extends into the bottle, a second, smaller generally semicircular region 66 extends further into the bottle from the center of the first semicircular region, and a plurality of ribs 67 extending radially outward from the second semicircular region 66. It should be noted that a small portion 68 of resin in the center of the second semicircular region 66 will often sag, thus making the second semicircular region 66 not completely semicircular in shape. It has been found that a base pushup depth greater than about 10 mm, and preferably about 11 mm to about 13 mm, and a pushup diameter in the range of about 49 mm to 50.5 mm, and preferably 50 mm to 50.5 mm, may be suitably used in accordance with the present invention.

The bottle of the present invention addresses the paneling problem created by PLA's relatively high water vapor transmission rate by utilizing a second portion 56 of the main body 53 of the bottle that has a different cross sectional shape than the first portion 55 of the main body 53 and a lower hoop stiffness than the first portion 55 of the main body 53.

As illustrated in FIGS. 10, 12A and 12B, the cross sectional shape of the first portion 55 of the main body 53 is substantially circular and the cross sectional shape of the second portion 56 of the main body 53 is substantially elliptical. A plurality of circumferential ribs 60 are used to add hoop stiffness to the first portion 55 of the main body 53 and no circumferential ribs are used on the second portion 56 of the main body 53. A plurality of longitudinally spaced arcuate projections 61 are positioned on the second portion 56 of the main body 53 at the ends of the minor axis A₂ of the elliptical cross sectional shape to add localized stiffness at these locations.

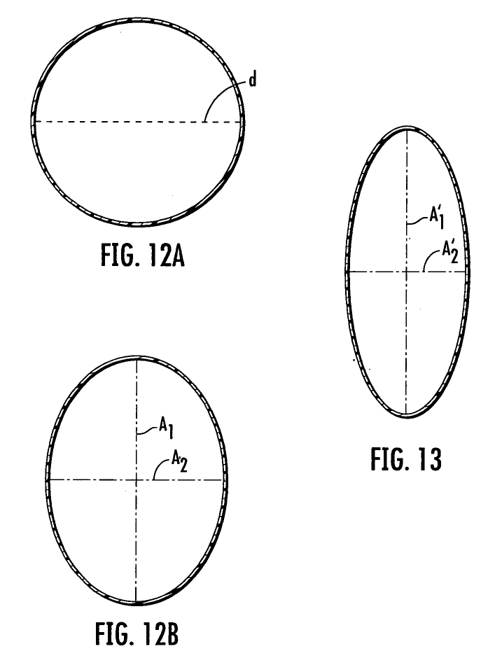

Deformation of the bottle of the present invention in response to vacuum creation inside the bottle is illustrated in FIGS. 12A, 12B and 13. FIGS. 12A and 12B illustrate, respectively, the cross sectional shapes of the first portion 55 of the main body 53 is substantially circular and the cross sectional shape of the second portion 56 of the main body 53 as such shapes exist before vacuum has been created inside the bottle. As water vapor permeates outwardly through the bottle, a vacuum is created inside the bottle. In response, the second portion 56 of the main body 53 deforms inwardly in a direction that is generally parallel to the minor axis A₂ of such portion and deforms outwardly in a direction that is generally parallel to the major axis A₁ of such portion. The resulting deformation is illustrated in FIG. 13, in which the length of the minor axis A₂′ after deformation is less than the length of the minor axis A₂ before such deformation and the length of the major axis A₁′ after deformation is greater than the length of the major axis A₁ before such deformation. In this way, hoop stiffness, localized stiffness and cross sectional body geometry are utilized to control the resulting shape of the bottle after vacuum-induced paneling. After such deformation the cross sectional shape of the first portion of the main body is substantially circular, just as before such deformation. Similarly, the cross section shape of the second portion of the main body after such deformation is substantially elliptical, just as before such deformation, but after such deformation the major axis thereof is longer and the minor axis thereof is shorter than before such deformation.

Preform stretch ratios are used to blow mold the biodegradable resin bottle of the present invention having round and oval cross-sectional areas. The term “preform stretch ratio” is well known to one of ordinary skill in the art and is typically defined by the following definitions.

The term “hoop stretch ratio,” as used herein, is defined as the ratio of the largest inner diameter (D1) of the blown article to the inner diameter (D2) of the body of the preform, or D1/D2.

The term “axial stretch ratio,” as used herein, is defined as the ratio of the height of the blown article below the threaded neck finish (AS1) to the height of the preform below the threaded neck finish (AS2), or AS1/AS2.

The term “overall stretch ratio,” as used herein, refers to the product of the hoop stretch ratio and the axial stretch ratio.

The axial stretch ratio is in a range of about 2 to about 3.2, preferably about 2.4 for a PLA bottle having been blow molded from a preform having a weight in the range of 21 g to 23.5 g, preferably about 22 g to 23 g. The hoop stretch ratio is in a range of about 3 to about 4, preferably about 3.5 to about 3.8 for a PLA bottle having been blow molded from a preform having a weight in the range of 21 g to 23.5 g, preferably about 22 g to 23 g. The overall stretch ratio is in a range of about 6 to 13, more preferably about 8 to 10 for a PLA bottle having been blow molded from a preform having a weight in the range of 21 g to 23.5 g, preferably about 22 g to 23 g.

### EXAMPLES

### Injection Mold Example

In this trial, PLA preforms were injection molded on the unit cavity Arburg injection molding press after the resin was dried for hours to a moisture level below 250 ppm. Preforms were made with ColorMatrix colorant #85-3243-5 at a 0.06% letdown ratio (LDR). The injection molding machine was prepared to run PLA by removing and cleaning the injection screw and barrel until free of PET. The injection molding conditions were optimized to produce a clear part with no visual defects and minimal molded-in stress. The injection molding conditions used are shown in the below tables.

TABLE 5
General Information

| Variable Description | 22.4 g PLA Preform with |
|---|---|
| | (85-3243-5 at 0.06%) |
| Machine | #6 Arburg 420 M |
| | (manufactured by |
| | ARBURG GmbH + Co KG) |
| Preform Weight (g) | 22.7 g |
| Relative Humidity | 30% |
| Dew Point (° F.) | 34.9 |
| Mold Temperature (° F.) | 60 |
| Ambient Temperature (° F.) | 67 |
| Dryer Temperature (° F.) | 175 |

TABLE 6
Barrel Temperatures

| | |
|---|---|
| Feed (° C.) | 216 |
| Zone 2 (° C.) | 216 |
| Zone 3 (° C.) | 215 |
| Zone 4 (° C.) | 215 |
| Nozzle (° C.) | 212 |

TABLE 7
Injection

| | |
|---|---|
| Injection Pressure 1 (bar) | 500 |
| Injection Pressure 2 (bar) | N/A |
| Injection Pressure 3 (bar) | N/A |
| Injection time (sec) | 2.1 |
| 1^{st} Injection Speed (ccm/sec) | 12.0 |
| 2^{nd} Injection Speed (ccm/sec) | 10.0 |
| 3^{rd} Injection Speed (ccm/sec) | 0.0 |

TABLE 8
Holding Pressure

| | |
|---|---|
| Switch-Over Point (ccm) | 10.0 |
| 1^{st} Hold Pressure (bar) | 350.0 |
| 2^{nd} Hold Pressure (bar) | 275.0 |
| 3^{rd} Hold Pressure (bar) | 200.0 |
| 4^{th} Hold Pressure (bar) | N/A |
| 1^{st} Hold Pressure Time (sec) | 2.0 |
| 2^{nd} Hold Pressure Time (sec) | 2.5 |
| 3^{rd} Hold Pressure Time (sec) | 2.0 |
| 4^{th} Hold Pressure Time (sec) | 0.0 |
| Remain Cool Time (sec) | 10.0 |

TABLE 9
Dosage

| | |
|---|---|
| Circumference Speed (m/min) | 12.0 |
| Back Pressure (bar) | 25.0 |
| Dosage Volume (ccm) | 27.0 |
| Measured Dosage Time (sec) | 3.0 |
| Cushion (ccm) | 5.4 |

TABLE 10
Adjustment Data

| | |
|---|---|
| Cycle Time (sec) | 23.7 |

### Blow Molding Example

A polylactic acid (PLA) preform having a weight of 22.7 g with a “26P” (standard flat water) finish was used.

This preform was to be used to blow mold a 500 mL PLA water bottle having substantially circular and substantially elliptical cross-sections in the main body of the bottle. The bottle had the following section weights:

TABLE 11

| Section | | |
|---|---|---|
| Description | Section Weight (g) | Cuts Height (mm) |
| Shoulder | 6.7 | 150-top |
| 1^{st} Portion of | 4.1 | 100-150 |
| Main Body | | |
| 2^{nd} Portion of | 6.3 | 22-100 |
| Main Body | | |
| Base | 5.6 | 0-22 |

At room temperature a preform was provided and turned upside down on a spindle, passed over a bank of ovens, and was heated with infrared (IR) heat lamps. The actual preform temperature was measured after the preform exited the oven. The actual preform temperature was measured as 83° C. The location on the preform where the temperature was measured was 30 mm above the support ledge or “finish” of the preform just prior to blow molding the preform. The heated preform subsequently was sent to a Side1 SBO2/3 blow molding machine. The body and base of the blow mold setpoint temperature was 45° F.

The preforms were heated in the oven with equilibration between oven banks and after exiting the oven before being blown. The blow molding speed was set at 2000 bottles per hour. The cam angle was 45 degrees. The stretch speed was 898.8 mm/s.

With respect to the heating of the preform prior to blow molding, the preform was heated using ten (10) lamps as “zones” within an oven bank. The percentage power refers to a percentage of power delivered to an individual lamp based upon the available power input. The percentage power that the bulb produced was set forth as a percentage. The position of the lamp was also indicated as “In” or “Out” whereby the “In” position was closer to the preform and the “Out” position was further away from the preform. For example, Zone 1 was nearer the support ledge or finish of the preform.

Each oven was set at the same overall power setting unless individual lamps were “off” or “on” in one oven. There was no ability to have different lamp settings in the same zone between ovens.

TABLE 12
Lamp Settings

| Lamp | Percentage | Oven | Oven | Oven | |
|---|---|---|---|---|---|
| Location | Power (%) | 1 | 2 | 3 | Position |
| Zone 10 | — | Off | Off | Off | |
| Zone 9 | — | Off | Off | Off | |
| Zone 8 | — | Off | Off | Off | |
| Zone 7 | 57.0 | On | On | Off | In |
| Zone 6 | 45.0 | On | On | Off | In |
| Zone 5 | 63.0 | On | On | Off | Out |
| Zone 4 | 40.0 | On | On | Off | Out |
| Zone 3 | 35.0 | On | On | Off | Out |
| Zone 2 | 45.0 | On | On | Off | Out |
| Zone 1 | 87.0 | On | On | On | In |

The entire ovens were moved as close to the preform as possible during the blow molding setup to most effectively heat the preform.

In addition to the ten (10) individual lamp settings; there was an overall power input that was used to adjust preform reheating. The overall power input to the ovens was represented as AL1 (standby) and AL2 (startup). The AL1 (standby) was set at 74% and the AL2 (startup) was set at 74%. Oven ventilation was used to cool the outside of the preform while heating it in the oven in order to get the heat to penetrate through the wall of the preform. The venting was set at 100%.

The preform was used to blow mold the PLA bottle. The preforms were placed into the blow mold and the stretch rod pushed the preform axially down into the bottom of the mold as preblow pressure air was applied to begin stretching. The stretch rod size was 10 mmf. The stop length was 12 inches.

“High blow” referred to the position where the very high pressure was applied to fully orient the preform into the bottle mold.

With respect to the blow pressures used for blow molding, the “low” blow was measured at 4 bar and the low blow flow was measured at 7.5 turns open. The low blow position was 37°. The “high” blow came on later and was measured at 32 bar and fully blew the bottle. The high blow position was 80°.

### Example —Bottle Material Distribution (Sidewall thickness) Profile

Material distribution data was obtained for a 22.4 g PLA bottle with a 26P finish having substantially circular and substantially elliptical cross-sections in the main body of the bottle.

A Top Wave GAWIS-STD was used to measure the wall thickness of twelve such bottles. Measurements were taken at 56 locations on the bottle, as shown in the following results table. Each bottle was measured at 16 height locations and four locations around the surface of the bottle. The data below is reported as the average of the bottle samples tested.

TABLE 13

| | | Height | | | | | |
|---|---|---|---|---|---|---|---|
| | Height | (inches | | | | | |
| | (as | con- | Subgroup | | | | |
| | measured | verted | Averages (inches) | | | | Standard |
| Location | in inches) | to mm) | 0° | 90° | 180° | 270° | Deviation |
| Shoulder | 7.288 | 185.1 | 0.018 | 0.020 | 0.018 | 0.020 | 0.001 |
| Shoulder | 6.788 | 172.4 | 0.012 | 0.012 | 0.012 | 0.013 | 0.000 |
| Shoulder | 6.288 | 159.7 | 0.012 | 0.012 | 0.013 | 0.012 | 0.000 |
| First | 5.788 | 147.0 | 0.012 | 0.013 | 0.013 | 0.014 | 0.001 |
| Portion of | | | | | | | |
| Main | | | | | | | |
| Body | | | | | | | |
| First | 5.288 | 134.3 | 0.013 | 0.013 | 0.014 | 0.014 | 0.001 |
| Portion of | | | | | | | |
| Main | | | | | | | |
| Body | | | | | | | |
| First | 4.788 | 121.6 | 0.012 | 0.013 | | | 0.000 |
| Portion of | | | | | | | |
| Main | | | | | | | |
| Body | | | | | | | |
| First | 4.668 | 119.1 | 0.012 | 0.013 | | | 0.001 |
| Portion of | | | | | | | |
| Main | | | | | | | |
| Body | | | | | | | |
| First | 4.400 | 111.8 | 0.010 | 0.011 | | | 0.000 |
| Portion of | | | | | | | |
| Main | | | | | | | |
| Body | | | | | | | |
| First | 4.380 | 111.3 | 0.011 | 0.012 | | | 0.000 |
| Portion of | | | | | | | |
| Main | | | | | | | |
| Body | | | | | | | |
| Second | 3.788 | 96.22 | 0.011 | 0.011 | 0.012 | 0.011 | 0.000 |
| Portion of | | | | | | | |
| Main | | | | | | | |
| Body | | | | | | | |
| Second | 3.288 | 83.52 | 0.013 | 0.013 | 0.014 | 0.013 | 0.001 |
| Portion of | | | | | | | |
| Main | | | | | | | |
| Body | | | | | | | |
| Second | 2.500 | 63.50 | 0.015 | 0.013 | 0.017 | 0.013 | 0.002 |
| Portion of | | | | | | | |
| Main | | | | | | | |
| Body | | | | | | | |
| Second | 1.788 | 45.42 | 0.013 | 0.015 | 0.017 | 0.015 | 0.002 |
| Portion of | | | | | | | |
| Main | | | | | | | |
| Body | | | | | | | |
| Second | 1.288 | 32.72 | 0.014 | 0.015 | 0.016 | 0.016 | 0.001 |
| Portion of | | | | | | | |
| Main | | | | | | | |
| Body | | | | | | | |
| Base | 0.669 | | 0.012 | 0.011 | 0.013 | 0.012 | 0.000 |
| Base | 0.321 | | 0.013 | 0.013 | 0.015 | 0.013 | 0.001 |

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An injection molded preform having a finish portion, a transition portion, a body portion, and a closed end cap portion for making a blow molded biodegradable bioresin bottle having a body comprising a substantially circular cross-section and a substantially elliptical cross-section in the body of the bottle, the preform comprising polylactic acid or polylactide.

2. An injection molded preform according to claim 1, wherein the preform has a weight in a range of from 21 g to 23.5 g.

3. An injection molded preform according to claim 1, wherein the preform has a weight in a range of from 22 g to 23 g.

4. An injection molded preform according to claim 1, wherein the preform is used for making a biodegradable resin bottle for a non-carbonated beverage.

5. An injection molded preform according to claim 4, wherein the non-carbonated beverage is water.

6. An injection molded preform having a finish portion, a transition portion, a body portion, and a closed end cap portion for making a blow molded biodegradable bioresin bottle having a body comprising a substantially circular cross-section and a substantially elliptical cross-section in the body of the bottle, the preform comprising polylactic acid or polylactide and having a preform weight in a range of from 22 g to 23 g.

7. An injection molded preform according to claim 6, wherein the transition portion of the preform has an inner diameter in a range of from 18 mm to 19 mm at its narrowest inner diameter.

8. An injection molded preform according to claim 7, wherein the transition portion of the preform has an inner diameter in a range of from 18 mm to 18.5 mm at its narrowest inner diameter.

9. An injection molded preform according to claim 6, wherein the transition portion of the preform has an external diameter in a range of from 23.5 mm to 24.5 mm its narrowest inner diameter.

10. An injection molded preform according to claim 6, wherein the preform is used for making a biodegradable resin bottle for a non-carbonated beverage.

11. An injection molded preform according to claim 10, wherein the non-carbonated beverage is water.

12. An injection molded preform according to claim 6, wherein the body portion of the preform has an inner diameter in the range of from 18 mm to 19 mm.

13. An injection molded preform according to claim 12, wherein the body portion of the preform has an inner diameter in the range of from 18 mm to 18.5 mm.

14. An injection molded preform according to claim 6, wherein the body portion of the preform has a length of from 57 mm to 58 mm.

15. An injection molded preform according to claim 6, wherein the body portion of the preform has an external diameter in a range of from 23.5 mm to 24.5 mm.

16. An injection molded preform according to claim 6, wherein the end cap portion of the preform has an inner diameter in a range of from 17 mm to 18 mm.

17. An injection molded preform according to claim 16, wherein the end cap portion of the preform has an inner diameter in a range of from 17.5 mm to 18 mm.

18. An injection molded preform according to claim 6, wherein the end cap portion of the preform has a length of from 11 mm to 12 mm.

19. An injection molded preform according to claim 6, wherein the end cap portion of the preform has an external diameter of from 23 mm to 24 mm.

20. A method of making a preform, the method comprising:
obtaining a bioresin comprising polylactide or polylactic acid,
drying the bioresin,
injection molding the bioresin in a mold to form a preform having a weight in a range of from 22 g to 23 g at an injection pressure in a range of from about 350 to about 700 bar for blow molding a biodegradable bioresin bottle having a main body comprising a substantially circular cross-section and a substantially elliptical cross-section in the main body of the bottle.

21. The method according to claim 20, wherein the injection pressure is about 500 bar.

22. The method according to claim 20, wherein the preform is injection molded at a mold temperature of at least about 12° C.

23. The method according to claim 22, wherein the mold temperature is in a range of about 23° C. to about 25° C.

24. The method according to claim 20, wherein the preform is injection molded at an injection speed in a range of about 10 ccm/s to about 20 ccm/s.

25. The method according to claim 20, wherein the preform is injection molded with a back pressure in a range of about 10 bar to about 30 bar.
